(19) United States
(12) Patent Application Publication
(10) Pub. No.: US 2009/0058312 A1
(43) Pub. Date: Mar. 5, 2009

(54) ENERGY EFFICIENT FLUORESCENT LAMP

(75) Inventors: Pieter Weijs, Malden (NL); Leendert Huibert Goud, Roosendaal (NL); Jos Van Meurs, Eindhoven (NL); Renatus Willem Clemens Van Der Veeken, Eindhoven (NL); Lukas Kastelein, Oss (NL); Jacobus Marinus Maria Claassens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/994,536

(22) PCT Filed: Jul. 3, 2006
(86) PCT No.: PCT/IB06/52228

§ 371 Date: Apr. 15, 2008

(30) Foreign Application Priority Data
Jul. 6, 2005 (EP) 05106120.8
Jul. 26, 2005 (EP) 05106875.7

(51) Int. Cl. H05B 41/00; H05B 41/36

(52) U.S. Cl. 315/193; 315/291; 315/209 R; 315/209 SC; 315/185 R

(57) ABSTRACT

To decrease a power consumption of a fluorescent lamp, the fluorescent lamp is provided with a high efficiency fluorescent coating, generating more light upon receipt of a conventional amount of radiation. Decreasing the power supplied to the lamp decreases the radiation supplied to the fluorescent coating and thus the light output of the lamp. Due to the increased light output of the fluorescent coating, the light output level of the fluorescent lamp may be kept substantially equal to a light output level of a conventional lamp.

The present invention relates to a fluorescent lamp and to a method for power saving in lighting applications.

Nowadays, in many technical fields, development is directed at power saving. In lighting applications, there is such an ongoing process of decreasing power consumption of lamps.

A known method for decreasing the power consumption of lighting is to dim a lamp using a kind of dimmer circuit and/or to switch off a lamp, when no light is needed, for example by sensing the presence of a person. However, in these methods, the lamp still uses a same amount of energy in an on-state, or the lamp has a lower light output level.

Fluorescent lamps, in particular electromagnetic operated lamps such as TL, are well-known energy-efficient lamps. These kind of lamps are matured in development and a further decrease of power consumption, while maintaining a conventional light output level, is difficult to obtain. In recent years, lamp modifications intended to decrease power consumption have only yielded a very small decrease (less than 5%).

It is an object of the present invention to provide a fluorescent lamp having low power consumption, while maintaining a conventional light output level.

The lamp according to the present invention as described in claim 1 achieves the above object by advantageously using improved fluorescent coatings to decrease the power consumption. The power-saving electronics decrease the power consumption and thereby the light output level, but due to the improved fluorescent coating, the light output may be kept on a conventional light output level.

In a fluorescent lamp, a fluorescent coating is irradiated with generated radiation, which is invisible to humans. The invisible radiation is converted to visible radiation, i.e. light, by the fluorescent coating. The fluorescent coatings used in fluorescent lamps have been improved over recent years. Due to the improvement in fluorescent coatings, the fluorescent coating outputs more visible light, when absorbing the same amount of radiation. Thus, the light output of fluorescent lamps has significantly increased. To the improved fluorescent coatings may be referred as high efficiency fluorescent coatings.

According to the present invention, less radiation is irradiated on the high efficiency fluorescent coating such that the light output is substantially equal to a conventional light output level. As less radiation is to be generated, the lamp may consume less power.

In an embodiment, the power saving electronics comprises a switching circuit, e.g. a TRIAC dimmer circuit, connected in series with electrodes of the fluorescent lamp. The switching circuit is configured to interrupt an energy flow to the discharge vessel during a relatively short period, e.g. a short period per cycle or half-cycle of an AC supply voltage. A TRIAC dimmer circuit is such a switching circuit well known in the art and may be cost-effectively manufactured and built-in into a conventional lamp housing, thereby enabling to retrofit the inventive lamp in existing electromagnetic lamp systems.

In an embodiment, the power-saving circuitry is connected between a ballast circuit and electrodes provided in the discharge vessel. Fluorescent lamps are usually operated using a ballast circuit for limiting the lamp current. Such a ballast circuit is usually separately provided. In operation, a discharge arc is present between the electrodes. Thereby, the desired radiation for exciting the fluorescent coating is generated. Connecting the power-saving circuitry between the ballast circuit and the electrodes enables to provide the power-saving circuitry within a casing of the fluorescent lamp. In such an embodiment the energy efficient lamp may replace conventional lamps without changes to the lighting system, providing a conventional light output, but consuming less power.

Below, the invention is further elucidated with reference to the non-limiting drawings, wherein:

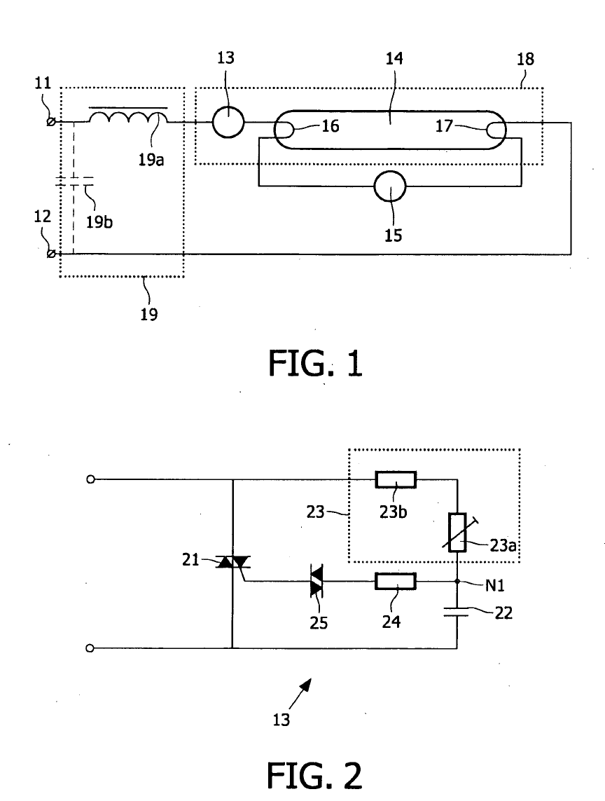

FIG. 1 shows an embodiment of a fluorescent lamp according to the present invention connected to a ballast;

FIG. 2 shows a schematic view of a power-saving circuitry for use in a fluorescent lamp according to the present invention;

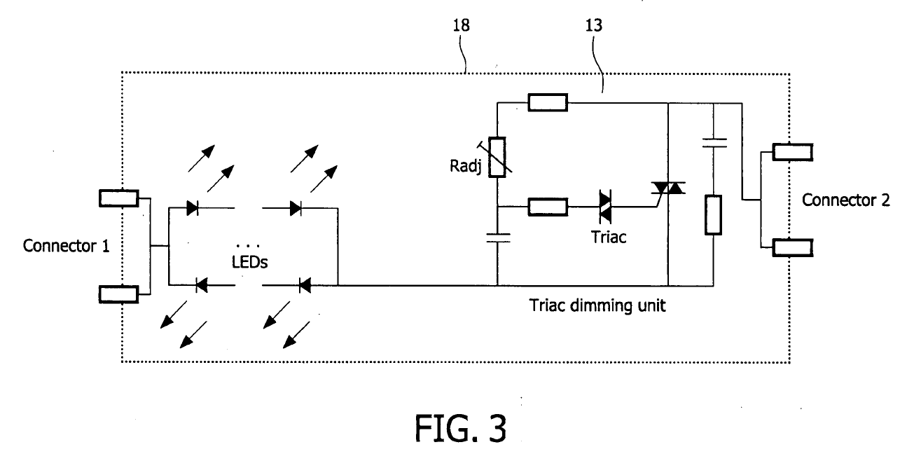

FIG. 3 shows a schematic view of a lamp unit according to the present invention comprising two anti-parallel strings of LEDs, power-saving circuitry and connector pins, and

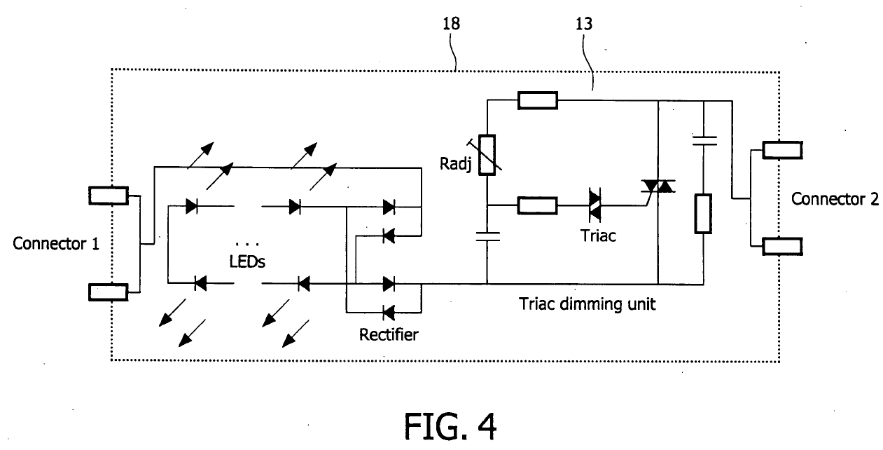

FIG. 4 shows a schematic view of a lamp unit according to the present invention comprising a single string of LEDs, a rectifier, power-saving circuitry and connector pins.

FIG. 1 illustrates a fluorescent lamp 18 (also called lamp unit) connected to a ballast 19 having two supply terminals 11, 12 for receiving a supply voltage. The fluorescent lamp or comprises a power-saving circuit 13 and a discharge vessel 14. 15 is a starter circuit connected across the discharge vessel. Within the discharge vessel two electrodes 16, 17 are provided. The discharge vessel 14 is filled with a suitable gas mixture such that a discharge current may be generated between the electrodes 16, 17. On an inner surface of the discharge vessel 14 a fluorescent coating is provided. The combination of the fluorescent coating and the gas mixture is such that a high light output level may be generated. In an embodiment, the starter circuit 15 may as well be integrated into the lamp unit. The dotted line 19 indicates a suitable ballast for operating the fluorescent lamp 1, for example comprising an inductor 19a and optionally a capacitor 19b connected in parallel with the lamp unit 18 and the inductor 19a.

FIG. 2 illustrates an example of suitable embodiment of a power-saving circuit 13 comprising a TRIAC dimmer circuit A TRIAC dimmer circuit is known in the art for dimming a number of kinds of lamps. The TRIAC dimmer circuit comprises a TRIAC 21 shunted by a series connection of a capacitor 22 and a resistor 23 possibly split in a resistor 23a having an adjustable resistance and a resistor 23b having a predetermined resistance. Between a control terminal of the TRIAC 21 a node N1 between the resistor 23 and the capacitor 22 a series connection of a resistor 24 and a DIAC 25 is connected. The TRIAC dimmer circuit is configured to block an AC current during a part of a half cycle of the AC current. The duration of said part depends inter alia on the resistance of the resistor 23 and the capacitance of the capacitor 22. Therefore, in common TRIAC dimmer circuits, the resistor 23 comprises a resistor 23a having an adjustable resistance. Adjusting the resistance of resistor 23 results in adjusting the light output of a lamp connected to the TRIAC dimmer circuit. In a power-saving circuit 13 according to an embodiment of the present invention, the resistance of resistor 23 may be predetermined to provide a predetermined light output level.

Now referring to FIGS. 1 and 2, as mentioned above, the fluorescent coating of the lamp 1 is a high efficiency fluorescent coating, e.g. an efficient phosphorus coating, such that with a conventional nominal power consumption, more light is output compared to the light output of a conventional fluorescent lamp. To lower the power consumption, the fluorescent lamp 1 is provided with the power-saving circuit 13, thereby lowering the light output. The power-saving circuit 13 may be configured such that in operation at least the light output level of a conventional lamp is obtained.

As mentioned above, the circuit 13 shown in FIG. 2 is a suitable power-saving circuit 13. The light output level of the lamp 1 is predetermined by selecting the resistance of resistor 23 and the capacitance of capacitor 22.

It has been found that power savings up to 60% are possible using a circuit as shown in FIG. 2. In practice, a power savings of at least 15% is obtainable, if the light output level is kept substantially equal to a conventional light output level.

With the power-saving circuitry build-in into the housing of a conventional lamp, the fluorescent lamp 1 in accordance with the present invention is usable in common conventional electromagnetic lamp systems, not requiring dedicated lamp systems.

It is remarked that in the lamp unit 18, the discharge vessel 14 and the starter circuit 15 may be replaced by two anti-parallel strings of LEDs, as is shown in FIG. 3. Alternatively, the discharge vessel 14 and the starter circuit 15 may be replaced by a rectifier and a single string of LEDs as shown in FIG. 4. Preferably, the lamp unit is further equipped with connection pins and so dimensioned that the lamp unit can be used as a retrofit lamp for a conventional fluorescent lamp. FIGS. 3 and 4 both show such a lamp unit.

1. Fluorescent lamp comprising a discharge vessel having a fluorescent coating on an inner surface, the fluorescent coating being of a high-efficiency type, wherein the lamp is provided with power-saving circuitry for controlling a supply current such that a conventional light output is obtainable.

2. Fluorescent lamp according to claim 1, wherein the power-saving circuitry comprises a switching circuit.

3. Fluorescent lamp according to claim 2, wherein the switching circuit is a TRIAC dimmer circuit.

4. Fluorescent lamp according to claim 1, wherein the power-saving circuitry is during operation connected between a ballast circuit and electrodes provided in the discharge vessel.

5. Fluorescent lamp according to claim 1, equipped with connector pins and so dimensioned that the fluorescent lamp can be used as a retrofit lamp replacing a conventional fluorescent lamp.

6. Lighting unit comprising a LED string coupled with power-saving circuitry for controlling a supply current such that a light output equal to that of a conventional fluorescent lamp is obtainable.

7. Lighting unit according to claim 6, comprising two anti-parallel LED strings connected with power-saving circuitry.

8. Lighting unit as claimed in claim 6, wherein the power saving circuitry comprises a switching circuit.

9. Lighting unit as claimed in claim 8, wherein the switching circuit is a TRIAC dimmer circuit.

10. Lighting unit according to claim 6, equipped with connector pins and so dimensioned that the lighting unit can be used as a retrofit lamp replacing a conventional fluorescent lamp.
